(19) United States
(12) Patent Application Publication
(10) Pub. No.: US 2026/0181499 A1
(43) Pub. Date: Jun. 25, 2026

(54) MEASUREMENT METHOD, APPARATUS, DEVICE, AND STORAGE MEDIUM

(71) Applicant: Beijing Xiaomi Mobile Software Co., Ltd., Beijing (CN)

(72) Inventors: Yi XIONG, Beijing (CN); Yumin WU, Beijing (CN)

(73) Assignee: Beijing Xiaomi Mobile Software Co., Ltd., Beijing (CN)

(21) Appl. No.: 19/126,898

(22) PCT Filed: Nov. 2, 2022
(86) PCT No.: PCT/CN2022/129265

§ 371 Date: May 2, 2025

(51) Int. Cl. H04W 36/00

(52) U.S. Cl. CPC H04W 36/0085

(57) ABSTRACT

A method for measurement, includes: in response to a first condition-based mobility configuration and a second condition-based mobility configuration being jointly configured, initiating at least one of a measurement or an evaluation corresponding to the first condition-based mobility configuration.

### CROSS REFERENCE TO RELATED APPLICATIONS

The present application is a U.S. National Stage of International Application No. PCT/CN2022/129265, filed on Nov. 2, 2022, all contents of which are incorporated herein by reference in their entireties for all purposes.

### TECHNICAL FIELD

The present disclosure relates to the field of communication technologies, and in particular, to a method for measurement, an apparatus, a device, and a storage medium.

### BACKGROUND

In a system for communication, the condition trigger-based mobility management is introduced. The process of the condition trigger-based mobility management includes that a terminal receives a condition-based mobility configuration configured by a network device, where the condition-based mobility configuration is associated with a candidate cell, and the condition-based mobility configuration corresponds to an execution condition. The terminal may perform a measurement and/or an evaluation corresponding to the condition-based mobility configuration, and may determine whether the measurement result and/or the evaluation result satisfies the execution condition of the condition-based mobility configuration. If it is satisfied, the terminal may perform corresponding mobility management on the candidate cell associated with the condition-based mobility configuration. The condition-based mobility configuration described above includes conditional handover (CHO) configuration, conditional primary secondary cell addition (CPA) configuration, conditional primary secondary cell change (CPA) configuration.

### SUMMARY

In a first aspect, according to some embodiments of the present disclosure, there is provided a method for measurement. The method is performed by a terminal, and includes:
in response to a first condition-based mobility configuration and a second condition-based mobility configuration being jointly configured, initiating a measurement and/or an evaluation corresponding to the first condition-based mobility configuration.

In a second aspect, according to some embodiments of the present disclosure, there is provided a method for measurement. The method is performed by a network device, and includes:
jointly configuring a first condition-based mobility configuration and a second condition-based mobility configuration to a terminal.

In a third aspect, according to some embodiments of the present disclosure, there is provided an apparatus for measurement. The apparatus for communication includes a processor and a memory. The memory stores a computer program, and the processor executes the computer program stored in the memory, so that the apparatus for communication performs the method according to the first aspect.

In an fourth aspect, according to some embodiments of the present disclosure, there is provided an apparatus for measurement. The apparatus for communication includes a processor and a memory. The memory stores a computer program, and the processor executes the computer program stored in the memory, so that the apparatus for communication performs the method according to the second aspect.

In a fifth aspect, according to some embodiments of the present disclosure, there is provided an apparatus for measurement. The apparatus includes a processor and an interface circuit. The interface circuit is configured to receive a code instruction and transmit the code instruction to the processor, and the processor is configured to run the code instruction to enable the apparatus to perform the method according to the first aspect.

In a sixth aspect, according to some embodiments of the present disclosure, there is provided an apparatus for measurement. The apparatus includes a processor and an interface circuit. The interface circuit is configured to receive a code instruction and transmit the code instruction to the processor, and the processor is configured to run the code instruction to enable the apparatus to perform the method according to second aspect.

In a seventh aspect, according to some embodiments of the present disclosure, there is provided a non-transitory computer-readable storage medium configured to store an instruction used by the foregoing network device and/or the foregoing terminal. When the instruction is executed, the terminal is enabled to perform the method according to the first aspect, and/or the network device is enabled to perform the method according to the second aspect.

### BRIEF DESCRIPTION OF THE DRAWINGS

The above aspects and/or additional aspects and advantages of the present disclosure will become apparent and more readily appreciated from the following descriptions made with reference to the accompanying drawings, in which:

FIG. 1 is a schematic architectural diagram of a system for communication provided according to some embodiments of the present disclosure;

FIG. 2a to FIG. 2c are schematic flowcharts of a method for measurement provided according to some embodiments of the present disclosure;

FIG. 3 is a schematic flowchart of a method for measurement provided according to some embodiments of the present disclosure;

FIG. 4 is a schematic flowchart of a method for measurement provided according to some embodiments of the present disclosure;

FIG. 5 is a schematic flowchart of a method for measurement provided according to some embodiments of the present disclosure;

FIG. 6 is a schematic flowchart of a method for measurement provided according to some embodiments of the present disclosure;

FIG. 7 is a schematic flowchart of a method for measurement provided according to some embodiments of the present disclosure;

FIG. 8 is a schematic flowchart of a method for measurement provided according to some embodiments of the present disclosure;

FIG. 9 is a schematic flowchart of a method for measurement provided according to some embodiments of the present disclosure;

FIG. 10 is a schematic flowchart of a method for measurement provided according to some embodiments of the present disclosure;

FIG. 11a to FIG. 11f are schematic flowcharts of a method for measurement provided according to some embodiments of the present disclosure;

FIG. 12 is a schematic flowchart of a method for measurement provided according to some embodiments of the present disclosure;

FIG. 13 is a schematic flowchart of a method for measurement provided according to some embodiments of the present disclosure;

FIG. 14a is a schematic flowchart of a method for measurement provided according to some embodiments of the present disclosure;

FIG. 14b is a schematic flowchart of a method for measurement provided according to some embodiments of the present disclosure;

FIG. 15 is a schematic structural diagram of an apparatus for communication provided according to some embodiments of the present disclosure;

FIG. 16 is a schematic structural diagram of an apparatus for communication provided according to some embodiments of the present disclosure;

FIG. 17 is a block diagram of an apparatus for communication provided according to some embodiments of the present disclosure;

FIG. 18 is a schematic structural diagram of a chip provided according to some embodiments of the present disclosure.

### DETAILED DESCRIPTION

Example embodiments will be described in detail here, examples of which are illustrated in the accompanying drawings. The following description refers to the accompanying drawings in which the same numbers in different drawings represent the same or similar elements unless otherwise represented. The implementations described in the following example embodiments do not represent all implementations consistent with the embodiments of the present disclosure. Instead, they are merely examples of apparatuses and methods consistent with some aspects of the embodiments of the present disclosure as detailed in the appended claims.

The terms used in the embodiments of the present disclosure are merely for the purpose of describing particular embodiments, and are not intended to limit the embodiments of the present disclosure. The singular forms “a” and “the” used in the embodiments of the present disclosure and the appended claims are also intended to include plural forms, unless the context clearly indicates other meanings. It should also be understood that the term “and/or” used here refers to and includes any or all possible combinations of one or more associated listed items.

It should be understood that although the terms “first”, “second”, “third”, or the like, may be used in the embodiments of the present disclosure to describe various information, these information should not be limited to these terms. These terms are only used to distinguish the same type of information from each other. For example, without departing from the scope of the embodiments of the present disclosure, first information may also be referred to as second information, and similarly, the second information may also be referred to as the first information. Depending on the context, the words “in case” and “if” as used here may be interpreted as “at the time” , or “when”, or “in response to determining”.

For ease of understanding, terms involved in the present disclosure are first described.

### 1. Multi Radio Access Technology Dual Connectivity (MR-DC)

MR-DC is a generalized intra-evolved universal terrestrial radio access (Intra-E-UTRA) dual connectivity, which may provide radio resources for a terminal by using two different scheduling nodes (that is, the terminal may access two base stations). The two scheduling nodes are connected to two different 5G radio access networks (i.e., Next Generation Radio Access Network, NG-RAN), for example, may be connected to the 5G radio access network through a non-ideal backhaul, where one scheduling node provides a new radio (NR) access to the terminal, and the other scheduling node provides an E-UTRA or NR access to the terminal. One scheduling node may serve as a master node (MN), and the other scheduling node may serve as a secondary node (SN), where the MN and the SN are connected through a network interface, and at least the MN is connected to the core network.

### 2. Conditional Handover (CHO)

CHO refers to the handover performed by the terminal when one or more handover execution conditions are satisfied. After receiving the CHO configuration, the terminal initiates to evaluate the execution condition, and stops evaluating the execution condition after performing the handover (including legacy handover and CHO).

3. Conditional Primary Secondary Cell (PSCell) Addition/Change (CPAC), including Conditional PSCell Addition (CPA), or Conditional PSCell Change (CPC).

CPA refers to addition of a primary secondary cell (PSCell) performed by the terminal when one or more handover execution conditions are satisfied. When receiving the CPA configuration, the terminal initiates to evaluate the execution condition, and stops evaluating the execution condition when PSCell addition is triggered.

CPC refers to change of the PSCell performed by the terminal when one or more handover execution conditions are satisfied. When receiving the CPC configuration, the terminal initiates to evaluate the execution condition, and stops evaluating the execution condition when PSCell change is triggered.

In a system for communication, in order to improve robustness and reduce the throughput of a terminal, the network device may jointly configure a CHO configuration and a CPAC configuration to the terminal. In some embodiments, jointly configuring the CHO configuration and the CPAC configuration includes: jointly configuring the CHO configuration and the CPA configuration; or, jointly configuring the CHO configuration and the CPC configuration. When the CHO configuration and the CPA configuration are jointly configured, and both the execution condition of the CHO configuration and the execution condition of the CPA configuration are satisfied, mobility managements corresponding to the CHO configuration and the CPA configuration may be performed simultaneously. When the CHO configuration and the CPC configuration are jointly configured, and both the execution condition of the CHO configuration and the execution condition of the CPC configuration are satisfied, mobility managements corresponding to the CHO configuration and the CPC configuration may be performed simultaneously.

Based on this, in the related art, there is provided a measurement method for the CHO configuration and the CPAC configuration that are jointly configured. In some embodiments, when the CHO configuration and the CPA configuration are jointly configured, all measurements corresponding to the CHO configuration are initiated, and all measurements corresponding to the CPA configuration are initiated, so as to determine which CHO configurations and CPA configurations that are jointly configured correspond to mobility managements that may be performed simultaneously. When the CHO configuration and the CPC configuration are jointly configured, measurements corresponding to all CHO configurations are initiated, and measurements corresponding to all CPC configurations are initiated, so as to determine which CHO configurations and CPC configurations that are jointly configured correspond to mobility managements that may be performed simultaneously.

However, in the method of the related art, the measurement frequency is high, the number of measurements required to be performed is large, the power consumption of the terminal is great, and the mobility management efficiency of the terminal is also reduced. Therefore, for the condition-based mobility configurations that are jointly configured, the present disclosure provides a method for measurement, in which the measurement frequency is lower, the required number of measurements is less, the power consumption is less, and the measurement efficiency is higher.

It should be noted that, in the present disclosure, the method for measurement provided according to any embodiment may be performed separately. Any implementation in the embodiment may also be performed separately, or may be performed in combination with other embodiments, or may be performed together with the possible implementation method in other embodiments, or may be performed together with any technical solution in the related art. It may be understood that the foregoing combination solutions all fall within the protection scope of the present disclosure.

For example, the embodiments provided in the present disclosure may be applied in a dual connectivity/carrier aggregation (DC/CA) scenario. In some embodiments, CA refers to that the terminal may use a plurality of cells (carriers) to perform uplink and downlink communication simultaneously, so as to support high-speed data transmission. Among the plurality of cells, one cell is the PCell, and another cell is a secondary cell (SCell). In some embodiments, DC refers to supporting that two base stations provide the data transmission service for one UE simultaneously. In some embodiments, one base station is a master base station, and the master base station may be referred to as a master gNB (MgNB) or a master node (MN). The other base station is a secondary base station, and the secondary base station may be referred to as a secondary gNB (SgNB) or a secondary node (SN). In some embodiments, the master base station is a control plane anchor. That is, an RRC connection is established between the terminal and the master base station, a control plane connection is established between the master base station and the core network, and an RRC message is transmitted between the master base station and the UE. In the subsequent enhancement technology, partial RRC messages (for example, measurement configuration information, measurement reports, etc.) may also be transmitted between the secondary base station and the UE. It may be understood that, the base station here is merely an example. It may be an independent base station, a DU, or a device having a protocol stack. In DC, a plurality of serving cells in the master base station form a master cell group (MCG), including a PCell or one or more SCells. A plurality of serving cells in the secondary base station form a secondary cell group (SCG), including one PSCell or one or more SCells. In some embodiments, the DC architecture may include, but is not limited to, the following three types: EN-DC (E-UTRA-NR Dual Connectivity), NE-DC (NR-E-UTRA Ddual Connectivity), and NGEN-DC (NG-RAN E-UTRA-NR Dual Connectivity). In addition to the foregoing three types of DC of LTE and NR, 5G also supports DC of NR and NR (NR-DC), or the like. For specific content of each architecture of the DC, reference may be made to related technologies, and are not described here.

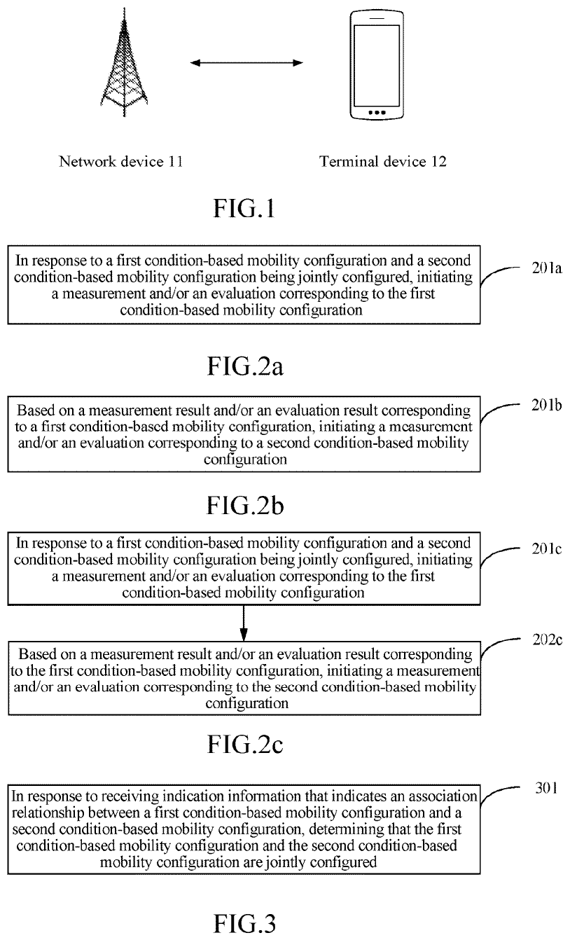

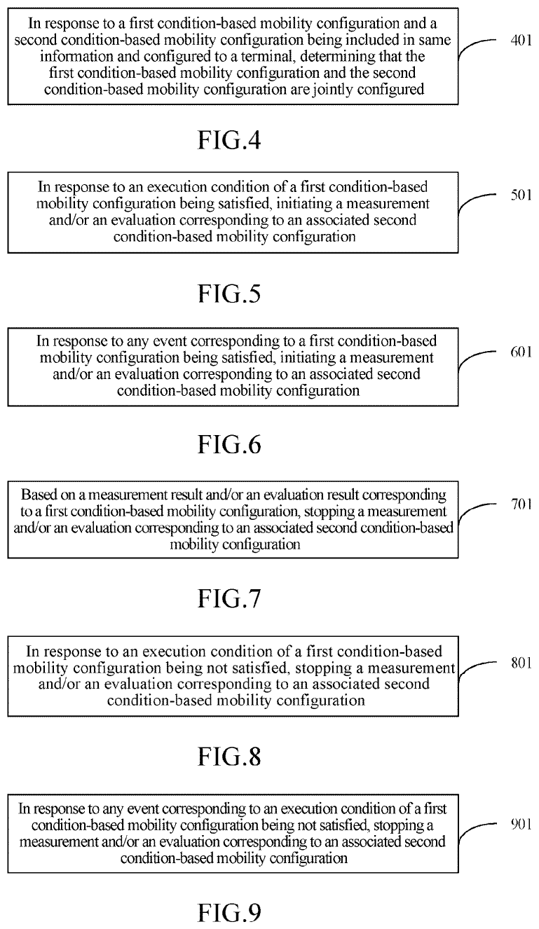

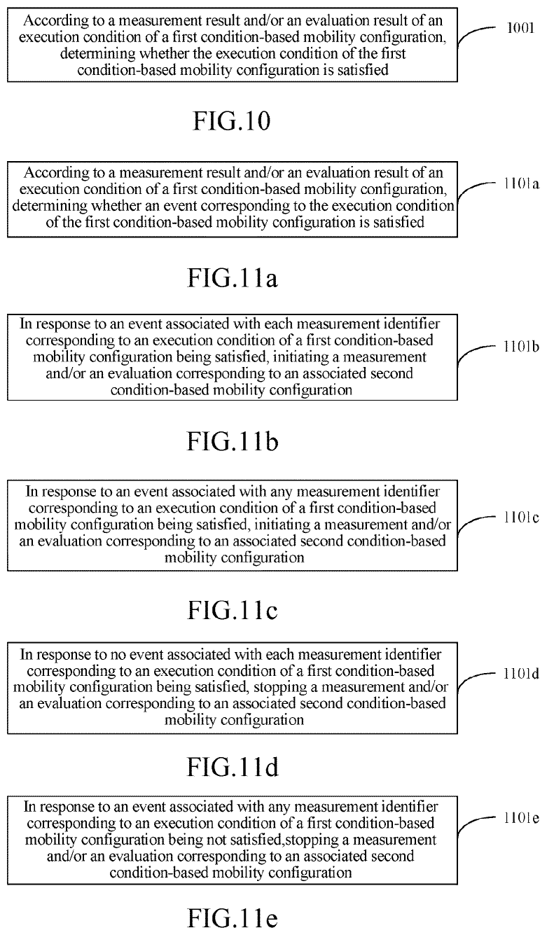

Referring to FIG. 1, FIG. 1 is a schematic architectural diagram of a system for communication provided according to some embodiments of the present disclosure. The system for communication may include, but is not limited to, at least one network device and at least one terminal. The number and form of devices shown in FIG. 1 are only used as examples, and do not constitute a limitation on the embodiments of the present disclosure. In the actual application, the system for communication may include two or more network devices, and two or more terminals. In the system for communication shown in FIG. 1, it takes an example that a network device 11 and a terminal 12 are included.

It should be noted that the technical solutions of the embodiments of the present disclosure may be applied to various system for communications, such as a long term evolution (LTE) system, a 5th generation (5G) mobile communication system, a 5G new radio (NR) system, another future new mobile communication system, or the like.

The network device 11 in the embodiments of the present disclosure is an entity, on the network side, for transmitting or receiving a signal. For example, the network device 11 may be an evolved NodeB (eNB), a transmission reception point (TRP), a next generation NodeB (gNB) in an NR system, a base station in another future mobile communication system, or an access node in a wireless fidelity (WiFi) system. The specific technology and the specific device form used by the network device are not limited in the embodiments of the present disclosure. The network device provided in the embodiments of the present disclosure may be composed of a central unit (CU) and a distributed unit (DU), where the CU may also be referred to as a control unit. By using the CU-DU structure, the network device, for example, the protocol layers of the base station, may be split. Functions of partial protocol layers are placed in the CU for centralized control, and functions of part or all of the remaining protocol layers are distributed in the DU, and the CU performs centralized control on the DU.

The terminal 12 in the embodiments of the present disclosure may be an entity, on the user side, for receiving or transmitting a signal, such as a mobile phone. The terminal may also be referred to as user equipment (UE), a mobile station (MS), a mobile terminal (MT), or the like. The terminal may be a car with a communication function, a smart car, a mobile phone, a wearable device, a tablet computer (PAD), a computer with a wireless transceiver function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in a smart home, or the like. The specific technology and the specific device form used by the terminal are not limited in the embodiments of the present disclosure.

It may be understood that the application scenario and the system for communication described in the embodiments of the present disclosure are intended to describe the technical solutions of the embodiments of the present disclosure more clearly, and do not constitute a limitation on the technical solutions provided in the embodiments of the present disclosure. Those of ordinary skill in the art may know that, as the evolution of the system architecture and the appearance of the new service scenario, the technical solutions provided in the embodiments of the present disclosure are also applicable to similar technical problems.

The method for measurement, the apparatus, the device, and the storage medium provided in the embodiments of the present disclosure are described in detail below with reference to the accompanying drawings.

FIG. 2a is a schematic flowchart of a method for measurement provided according to some embodiments of the present disclosure. The method is performed by a terminal. As shown in FIG. 2a, the method for measurement may include the following step.

In step 201a, in response to a first condition-based mobility configuration and a second condition-based mobility configuration being jointly configured, a measurement and/or an evaluation corresponding to the first condition-based mobility configuration is initiated.

“Condition-based mobility configuration” mentioned in the present disclosure is described below. In some embodiments of the present disclosure, the condition-based mobility configuration is used to perform mobility management on the terminal. The mobility management of the terminal includes, but is not limited to, a handover operation, a change operation, an addition operation, or the like. In addition, the condition-based mobility configuration is associated with a candidate cell, where the manner of associating the candidate cell with the condition-based mobility configuration may be that the identifier of the candidate cell is included in the condition-based mobility configuration, so as to implement the association between the candidate cell and the condition-based mobility configuration. Further, the condition-based mobility configuration may be used to determine when to perform mobility management corresponding to the condition-based mobility configuration on the candidate cell associated with the condition-based mobility configuration. Specifically, in some embodiments of the present disclosure, the condition-based mobility configuration may include, for example, an execution condition, where the execution condition corresponds to at least one event. When all events corresponding to the execution condition of the condition-based mobility configuration are satisfied, it is considered that the execution condition of the condition-based mobility configuration is satisfied, and then, it is determined to perform corresponding mobility management on the candidate cell associated with the condition-based mobility configuration.

In some embodiments of the present disclosure, the event may be a measurement result-based event, a location-based event, a height-based event, a time-based event, or the like. It is illustrated below by taking the event being a measurement result-based event as an example, and the principles of other location-based events or time-based events or height-based events are similar.

In some embodiments of the present disclosure, the foregoing measurement result-based event may be understood as that it is evaluated, based on a measurement result, whether the event is satisfied. Specifically, the measurement result-based event is associated with a measurement identifier, and the measurement identifier is at least used to determine a measurement content. The measurement content is used to indicate a measurement to be performed by the terminal. The measurement content may include, for example, measurement of a reference signal receiving power (RSRP) of an uplink signal of the terminal and/or a reference signal receiving quality (RSRQ) of the uplink signal, or the like. In some embodiments, the terminal may perform corresponding measurement on the associated candidate cell based on the measurement identifier and obtain a measurement result. Then, the terminal may evaluate, according to the measurement result, whether the event associated with the measurement identifier is satisfied, and obtain an evaluation result. The evaluation result may be that the event is satisfied or the event is not satisfied. When it is determined that all events corresponding to the execution condition of the condition-based mobility configuration are satisfied, it is determined that the execution condition of the condition-based mobility configuration is satisfied; otherwise, it is determined that the execution condition of the condition-based mobility configuration is not satisfied. In some embodiments, when it is determined that the execution condition of the condition-based mobility configuration is satisfied, corresponding mobility management may be performed on the candidate cell associated with the condition-based mobility configuration.

In some embodiments, the first condition-based mobility configuration may be a CHO configuration or a CPAC configuration, where the CPAC configuration may be a CPA configuration or a CPC configuration. The second condition-based mobility configuration may also be a CHO configuration or a CPAC configuration, where the CPAC configuration may be a CPA configuration or a CPC configuration. Moreover, the first condition-based mobility configuration is different from the second condition-based mobility configuration. In an example, the first condition-based mobility configuration is specifically a CHO configuration, the second condition-based mobility configuration is a CPAC configuration, and more specifically, the second condition-based mobility configuration is a CPA configuration or a CPC configuration. In another example, the first condition-based mobility configuration is a CPAC configuration, more specifically, the first condition-based mobility configuration is a CPA configuration or a CPC configuration, and the second condition-based mobility configuration is specifically a CHO configuration.

It should be noted that “the first condition-based mobility configuration” and “the second condition-based mobility configuration” of the present disclosure are only used to represent the condition-based handover function configurations, and the naming itself does not constitute a limitation on the substantive content of the technical solutions of the present disclosure.

For example, it is assumed that mobility management corresponding to the condition-based mobility configuration is handover (for example, CHO), the candidate cell associated with the condition-based mobility configuration is the candidate cell #1, the execution condition of the condition-based mobility configuration corresponds to two events that are the event 1 and an event 2 respectively, the event 1 is associated with the measurement identifier #1, and the event 2 is associated with the measurement identifier #2. In some embodiments, the measurement content indicated by the measurement identifier #1 is measurement of the reference signal receiving power (RSRP), and the event 1 is the measured RSRP being greater than a first value, the measurement content indicated by the measurement identifier #2 is measurement of the signal to interference plus noise ratio (SINR), and the event 2 is the measured SINR being greater than a second value. Based on this, the terminal may measure the RSRP and the SINR of the candidate cell #1. If the measured RSRP is greater than the first value and the measured SINR is greater than the second value, it indicates that all events (i.e. event 1 and event 2) corresponding to the execution condition of the condition-based mobility configuration are satisfied. That is, the execution condition of the condition-based mobility configuration is satisfied. At this time, corresponding mobility management may be performed on the candidate cell #1; that is, it may be handed over to the candidate cell #1.

Further, in some embodiments of the present disclosure, the foregoing “the first condition-based mobility configuration and the second condition-based mobility configuration being jointly configured” may include that, in response to the terminal receiving indication information that indicating an association relationship between the first condition-based mobility configuration and the second condition-based mobility configuration, it is determined that the first condition-based mobility configuration and the second condition-based mobility configuration are jointly configured, where the indication information may be transmitted to the terminal through RRC signaling.

In some embodiments of the present disclosure, the foregoing “the first condition-based mobility configuration and the second condition-based mobility configuration being jointly configured” may include that, in response to the first condition-based mobility configuration and the second condition-based mobility configuration being included in the same information and configured to the terminal, it is determined that the first condition-based mobility configuration and the second condition-based mobility configuration are jointly configured, where the same information may further include the association relationship between the first condition-based mobility configuration and the second condition-based mobility configuration. The same information may be the same message or the same signaling, where, for example, the message may be configuration information of conditional reconfiguration, the configuration information of conditional reconfiguration may be transmitted by using RRC signaling, and the signaling may be RRC signaling.

Furthermore, in some embodiments of the present disclosure, the foregoing “the first condition-based mobility configuration and the second condition-based mobility configuration being jointly configured” may be understood as that, when the first condition-based mobility configuration and the second condition-based mobility configuration are jointly configured, only in a case that the execution condition of the first condition-based mobility configuration is satisfied and the execution condition of the second condition-based mobility configuration is satisfied, the mobility management corresponding to the first condition-based mobility configuration and the mobility management corresponding to the second condition-based mobility configuration may be performed; otherwise, the mobility management corresponding to the first condition-based mobility configuration and/or the mobility management corresponding to the second condition-based mobility configuration are not performed.

Therefore, when the first condition-based mobility configuration and the second condition-based mobility configuration are jointly configured, it is usually needed to initiate the measurement and/or the evaluation corresponding to the first condition-based mobility configuration, and initiate the measurement and/or the evaluation corresponding to the second condition-based mobility configuration. In some embodiments of the present disclosure, when the first condition-based mobility configuration and the second condition-based mobility configuration are jointly configured, step 201 a may usually be performed first, that is, the measurement and/or the evaluation corresponding to the first condition-based mobility configuration may be initiated; and then, the subsequent step may be performed to initiate the measurement and/or the evaluation corresponding to the second condition-based mobility configuration.

It should be noted that, in some embodiments of the present disclosure, the foregoing “initiating the measurement and/or the evaluation corresponding to the first condition-based mobility configuration” may include initiating the measurement and/or the evaluation corresponding to at least one event corresponding to the execution condition of the first condition-based mobility configuration. For detailed descriptions of initiating the measurement and/or the evaluation corresponding to at least one event corresponding to the execution condition of the condition-based mobility configuration in this part of content, reference may be made to the description of the foregoing embodiments.

In summary, in the method for measurement provided in the embodiments of the present disclosure, in response to the first condition-based mobility configuration and the second condition-based mobility configuration being jointly configured, the terminal initiates the measurement and/or the evaluation corresponding to the first condition-based mobility configuration to obtain the measurement result and/or the evaluation result of the first condition-based mobility configuration, so that the terminal may subsequently determine, based on the measurement result and/or the evaluation result, which second condition-based mobility configurations are to be subjected to an measurement and/or an evaluation, thus ensuring that the measurement of the second condition-based mobility configuration may be initiated smoothly, and ensuring that subsequent operations may be performed smoothly.

FIG. 2b is a schematic flowchart of a method for measurement provided according to some embodiments of the present disclosure. The method is performed by a terminal. As shown in FIG. 2b, the method for measurement may include the following step.

In step 201b, a measurement and/or an evaluation corresponding to the second condition-based mobility configuration are initiated based on a measurement result and/or an evaluation result corresponding to the first condition-based mobility configuration.

In some embodiments of the present disclosure, when the measurement and/or the evaluation corresponding to the second condition-based mobility configuration is initiated, it is “initiating the measurement and/or the evaluation corresponding to the second condition-based mobility configuration based on the measurement result and/or the evaluation result corresponding to the first condition-based mobility configuration. Then, it may be implemented that the measurement and/or the evaluation corresponding to the second condition-based mobility configuration is selectively screened and initiated based on the measurement result and/or the evaluation result corresponding to the first condition-based mobility configuration, instead of that all measurements corresponding to the second condition-based mobility configuration are performed. Therefore, the measurement frequency and the required number of measurements may be effectively reduced, the additional power consumption of the terminal may be reduced, and the execution efficiency of the mobility management may be improved.

In summary, in the method for measurement provided in the embodiments of the present disclosure, the terminal initiates the measurement and/or the evaluation corresponding to the second condition-based mobility configuration based on the measurement result and/or the evaluation result corresponding to the first condition-based mobility configuration. Compared with simultaneously initiating all of the measurement and/or the evaluation corresponding to the first condition-based mobility configurations and the measurement and/or the evaluation corresponding to the second condition-based mobility configuration, the measurement frequency and the required number of measurements may be effectively reduced in the present disclosure, thus reducing the additional power consumption of the terminal, and improving the execution efficiency of the mobility management.

FIG. 2c is a schematic flowchart of a method for measurement provided according to some embodiments of the present disclosure. The method is performed by a terminal. As shown in FIG. 2c, the method for measurement may include the following steps.

In step 201c, in response to a first condition-based mobility configuration and a second condition-based mobility configuration being jointly configured, a measurement and/or an evaluation corresponding to the first condition-based mobility configuration are initiated.

In step 202c, a measurement and/or an evaluation corresponding to the second condition-based mobility configuration are initiated based on a measurement result and/or an evaluation result corresponding to the first condition-based mobility configuration.

For detailed descriptions of steps 201c to 202c, reference may be made to the descriptions of the foregoing embodiments.

In summary, in the method for measurement provided in the embodiments of the present disclosure, in response to the first condition-based mobility configuration and the second condition-based mobility configuration being jointly configured, the terminal may initiate the measurement and/or the evaluation corresponding to the first condition-based mobility configuration; and then, the terminal may initiate the measurement and/or the evaluation corresponding to the second condition-based mobility configuration based on the measurement result and/or the evaluation result corresponding to the first condition-based mobility configuration. Compared with simultaneously initiating all of the measurement and/or the evaluation corresponding to the first condition-based mobility configurations and the measurement and/or the evaluation corresponding to the second condition-based mobility configuration, the measurement frequency and the required number of measurements may be effectively reduced in the present disclosure, thus reducing the additional power consumption of the terminal, and improving the execution efficiency of mobility management.

FIG. 3 is a schematic flowchart of a method for measurement provided according to some embodiments of the present disclosure. The method is performed by a terminal. As shown in FIG. 3, the method for measurement may include the following step.

In step 301, in response to receiving indication information that indicates an association relationship between a first condition-based mobility configuration and a second condition-based mobility configuration, it is determined that the first condition-based mobility configuration and the second condition-based mobility are jointly configured.

In some embodiments of the present disclosure, no matter the first condition-based mobility configuration and the second condition-based mobility configuration are respectively configured by the network device to the terminal, or are simultaneously configured by the network device to the terminal, when the terminal receives the indication information, and the indication information indicates the association relationship between the first condition-based mobility configuration and the second condition-based mobility configuration, it is determined that the first condition-based mobility configuration and the second condition-based mobility configuration are jointly configured.

In some embodiments of the present disclosure, the first condition-based mobility configuration may be configured by the network device to the terminal by using the configuration information of conditional reconfiguration, and the second condition-based mobility configuration may be configured by the network device to the terminal by using the configuration information of conditional reconfiguration. The configuration information of conditional reconfiguration may be transmitted through radio resource control (RRC) signaling.

In some embodiments of the present disclosure, the indication information may be transmitted to the terminal through RRC signaling.

In summary, in the method for measurement provided in the embodiments of the present disclosure, in response to receiving the indication information that indicates the association relationship between the first condition-based mobility configuration and the second condition-based mobility configuration, the terminal may determine that the first condition-based mobility configuration and the second condition-based mobility configuration are jointly configured. It can be seen from this that, the present disclosure provides a joint configuration method used for jointly configuring the first condition-based mobility configuration and the second condition-based mobility configuration.

FIG. 4 is a schematic flowchart of a method for measurement provided according to some embodiments of the present disclosure. The method is performed by a terminal. As shown in FIG. 4, the method for measurement may include the following step.

In step 401, in response to a first condition-based mobility configuration and a second condition-based mobility configuration being included in same information and configured to the terminal, it is determined that the first condition-based mobility configuration and the second condition-based mobility configuration are jointly configured.

In some embodiments of the present disclosure, the same information may be the same message or the same signaling, where, for example, the message may be configuration information of conditional reconfiguration, the configuration information of conditional reconfiguration may be transmitted by using RRC signaling, and the signaling may be RRC signaling.

In some embodiments of the present disclosure, if the first condition-based mobility configuration and the second condition-based mobility configuration are included in the same information and configured to the terminal, it implicitly indicates that the first condition-based mobility configuration and the second condition-based mobility configuration are jointly configured. In this case, the terminal may store the information, so as to subsequently initiate the measurement and/or the evaluation corresponding to the first condition-based mobility configuration and/or the second condition-based mobility configuration based on the stored information.

Furthermore, in some embodiments of the present disclosure, the information may further include an association relationship between the first condition-based mobility configuration and the second condition-based mobility configuration.

In summary, in the method for measurement provided in the embodiments of the present disclosure, in response to the first condition-based mobility configuration and the second condition-based mobility configuration being included in the same information and configured to the terminal, it is determined that the first condition-based mobility configuration and the second condition-based mobility configuration are jointly configured. It can be seen from this that, the present disclosure provides a joint configuration method used for jointly configuring the first condition-based mobility configuration and the second condition-based mobility configuration. In addition, in the method of the present disclosure, joint configuration is implemented by “including the first condition-based mobility configuration and the second condition-based mobility configuration in the same information”, without transmitting other additional information, thus reducing the signaling overhead.

FIG. 5 is a schematic flowchart of a method for measurement provided according to some embodiments of the present disclosure. The method is performed by a terminal. As shown in FIG. 5, the method for measurement may include the following step.

In step 501, in response to an execution condition of a first condition-based mobility configuration being satisfied, a measurement and/or an evaluation corresponding to an associated second condition-based mobility configuration is initiated.

In some embodiments, it can be seen from step 501 that, in the present disclosure, when the first condition-based mobility configuration and the second condition-based mobility configuration are associated with each other and configured, the measurement and/or the evaluation corresponding to the first condition-based mobility configuration are performed first in the present disclosure. After the measurement result and/or the evaluation result corresponding to the first condition-based mobility configuration are obtained, for the second condition-based mobility configuration associated with the first condition-based mobility configuration with the execution condition being satisfied, the corresponding measurement and/or evaluation are initiated based on the measurement result and/or the evaluation result. For the second condition-based mobility configuration associated with the first condition-based mobility configuration with the execution condition being not satisfied, the corresponding measurement and/or evaluation are not initiated. That is, not all measurements and/or evaluations corresponding to the second condition-based mobility configuration are initiated.

For example, the network device configures the first condition-based mobility configuration #1 and the second condition-based mobility configuration #2 associated with the first condition-based mobility configuration #1 to the terminal. In some embodiments, the terminal may first initiate the measurement and/or the evaluation corresponding to the first condition-based mobility configuration #1. If it is measured that the execution condition of the first condition-based mobility configuration #1 is satisfied, the terminal further initiates the measurement and/or the evaluation corresponding to the second condition-based mobility configuration #2. If it is measured that the execution condition of the first condition-based mobility configuration #1 is not satisfied, the terminal does not initiate the measurement and/or the evaluation corresponding to the second condition-based mobility configuration #2.

It can be seen from this that, in the method of the present disclosure, after the measurement and/or the evaluation corresponding to the first condition-based mobility configuration are initiated, not all measurements and/or evaluations corresponding to the second condition-based mobility configuration are initiated, but only the measurement and/or the evaluation corresponding to the second condition-based mobility configuration associated with the first condition-based mobility configuration with the execution condition being satisfied are initiated. Compared with “simultaneously initiating measurements corresponding to all CHO configuration and measurements corresponding to all CPA configurations or CPC configurations associated with all CHO configurations” in the related art, the measurement frequency and the required number of measurements are greatly reduced, the additional power consumption of the terminal is reduced, and the execution efficiency of the mobility management is improved.

In addition, it should be noted that, in some embodiments of the present disclosure, the foregoing “the execution condition of the first condition-based mobility configuration being satisfied” may be understood as that all events corresponding to the execution condition of the first condition-based mobility configuration are satisfied.

For example, if the execution condition of the first condition-based mobility configuration corresponds to the event 1, and when the event 1 is satisfied, it is considered that the execution condition of the first condition-based mobility configuration is satisfied. In some embodiments, if the execution condition of the first condition-based mobility configuration corresponds to the event 1 and the event 2, and when both the event 1 and the event 2 are satisfied, it is considered that the execution condition of the first condition-based mobility configuration is satisfied.

In summary, in the method for measurement provided in the embodiments of the present disclosure, in response to the execution condition of the first condition-based mobility configuration being satisfied, the terminal device may initiate the measurement and/or the evaluation corresponding to the associated second condition-based mobility configuration. Compared with simultaneously initiating measurements and/or evaluations corresponding to all first condition-based mobility configurations and all second condition-based mobility configurations, the measurement frequency and the required number of measurements may be reduced in the present disclosure, thus improving the measurement speed and measurement efficiency.

FIG. 6 is a schematic flowchart of a method for measurement provided according to some embodiments of the present disclosure. The method is performed by a terminal. As shown in FIG. 6, the method for measurement may include the following step.

In step 601, in response to any event corresponding to an execution condition of a first condition-based mobility configuration being satisfied, a measurement and/or an evaluation corresponding to an associated second condition-based mobility configuration are initiated.

Referring to step 601, it can be known that, in the present disclosure, when the first condition-based mobility configuration and the second condition-based mobility configuration are associated with each other and configured, the measurement and/or the evaluation corresponding to the first condition-based mobility configuration are first performed in the present disclosure. After the measurement result and/or the evaluation result corresponding to the first condition-based mobility configuration are obtained, only for the second condition-based mobility configuration associated with the first condition-based mobility configuration with any event being satisfied, the corresponding measurement and/or the evaluation are initiated based on the measurement result and/or the evaluation result, rather than all measurements and/or evaluations corresponding to the second condition-based mobility configuration being initiated.

For example, it is assumed that the network device configures a first condition-based mobility configuration #1 and a second condition-based mobility configuration #2 associated with the first condition-based mobility configuration #1 to the terminal, where the execution condition of the first condition-based mobility configuration #1 corresponds to the event 1 and the event 2. In this case, the terminal may first initiate the measurement and/or the evaluation corresponding to the first condition-based mobility configuration #1. If it is measured that the event 1 corresponding to the execution condition of the first condition-based mobility configuration #1 is satisfied, the terminal may further initiate the measurement and/or the evaluation corresponding to the second condition-based mobility configuration #2.

It can be seen from this that, in the method of the present disclosure, after the measurement and/or the evaluation corresponding to the first condition-based mobility configuration are initiated, not all measurements and/or evaluations corresponding to the second condition-based mobility configuration are initiated, but only the measurement and/or the evaluation corresponding to the second condition-based mobility configuration associated with the first condition-based mobility configuration with any event being satisfied are initiated. Compared with “simultaneously initiating measurements corresponding to all CHO configurations and measurements corresponding to all CPA configurations or CPC configurations associated with all CHO configurations” in the related art, the measurement frequency and the required number of measurements are greatly reduced, the additional power consumption of the terminal is reduced, and the execution efficiency of mobility management is improved.

In addition, it should be noted that, with respect to the detailed description of the foregoing “measurement and/or evaluation”, reference may be made to the foregoing embodiments.

In summary, in the method for measurement provided in the embodiments of the present disclosure, in response to any event corresponding to the execution condition of the first condition-based mobility configuration being satisfied, the terminal may initiate the measurement and/or the evaluation corresponding to the second condition-based mobility configuration. Compared with simultaneously initiating measurements and/or evaluations corresponding to all first condition-based mobility configurations and all second condition-based mobility configurations, the required of measurement amount may be greatly reduced in the present disclosure, thus reducing the power consumption required for the measurements and avoiding additional resource or power consumption.

FIG. 7 is a schematic flowchart of a method for measurement provided according to some embodiments of the present disclosure. The method is performed by a terminal. As shown in FIG. 7, the method for measurement may include the following step.

In step 701, based on a measurement result and/or an evaluation result corresponding to a first condition-based mobility configuration, a measurement and/or an evaluation corresponding to an associated second condition-based mobility configuration are stopped.

It can be seen from the foregoing content that, when the first condition-based mobility configuration and the second condition-based mobility configuration are jointly configured, only when the execution condition of the first condition-based mobility configuration is satisfied and the execution condition of the second condition-based mobility configuration is also satisfied, the mobility management corresponding to the first condition-based mobility configuration and the mobility management corresponding to the second condition-based mobility configuration may be performed. If the execution condition of the first condition-based mobility configuration is not satisfied, or the execution condition of the second condition-based mobility configuration is not satisfied, it is not possible to perform the mobility management corresponding to the first condition-based mobility configuration and the mobility management corresponding to the second condition-based mobility configuration.

Based on this, in some embodiments, in the process of initiating the measurement and/or the evaluation corresponding to the second condition-based mobility configuration, the measurement and/or the evaluation corresponding to the first condition-based mobility configuration may also be maintained. In some embodiments, since the situation of the candidate cell associated with the first condition-based mobility configuration may change in real time, there may be a situation that the execution condition of the first condition-based mobility configuration changes from being satisfied previously to being unsatisfied. In some embodiments, when the execution condition of the first condition-based mobility configuration is not satisfied, whether the execution condition of the second condition-based mobility configuration is satisfied or not, it may result in that the mobility management corresponding to the first condition-based mobility configuration and the mobility management corresponding to the second condition-based mobility configuration cannot be performed. In this case, “the process of the measurement and/or the evaluation corresponding to the second condition-based mobility configuration” becomes a meaningless unnecessary process, and then, the measurement and/or the evaluation corresponding to the second condition-based mobility configuration may be stopped, so as to avoid unnecessary operations.

In some embodiments of the present disclosure, in the previous step, if it is measured that any event corresponding to the execution condition of the first condition-based mobility configuration is satisfied, the measurement and/or the evaluation corresponding to the second condition-based mobility configuration are initiated. In this case, in the process of initiating the measurement and/or the evaluation corresponding to the second condition-based mobility configuration, the measurement and/or the evaluation corresponding to other events corresponding to the execution condition of the first condition-based mobility configuration are also synchronously performed. If it is measured that other events are not satisfied, it indicates that the execution condition of the first condition-based mobility configuration is not satisfied. Similarly, in this case, “the process of the measurement and/or the evaluation corresponding to the second condition-based mobility configuration” becomes a meaningless unnecessary process, and the measurement and/or the evaluation corresponding to the second condition-based mobility configuration may be stopped, so as to avoid unnecessary operations.

In summary, in the method for measurement provided in the embodiments of the present disclosure, based on the measurement result and/or the evaluation result corresponding to the first condition-based mobility configuration, the terminal may stop the measurement and/or the evaluation corresponding to the second condition-based mobility configuration. In this way, some unnecessary measurements may be stopped in time, thus avoiding unnecessary operations.

FIG. 8 is a schematic flowchart of a method for measurement provided according to some embodiments of the present disclosure. The method is performed by a terminal. As shown in FIG. 8, the method for measurement may include the following step.

In step 801, in response to an execution condition of a first condition-based mobility configuration being not satisfied, a measurement and/or an evaluation corresponding to an associated second condition-based mobility configuration are stopped.

In some embodiments, in the process of initiating the measurement and/or the evaluation corresponding to the second condition-based mobility configuration, the measurement and/or the evaluation corresponding to the first condition-based mobility configuration may also be maintained. In some embodiments, since the situation of the candidate cell associated with the first condition-based mobility configuration may change in real time, there may be a situation that the execution condition of the first condition-based mobility configuration changes from being satisfied previously to being unsatisfied. In some embodiments, when the execution condition of the first condition-based mobility configuration is not satisfied, whether the execution condition of the second condition-based mobility configuration is satisfied or not, it may result in that the mobility management corresponding to the first condition-based mobility configuration and the mobility management corresponding to the second condition-based mobility configuration cannot be performed. In this case, “the process of the measurement and/or the evaluation corresponding to the second condition-based mobility configuration” becomes a meaningless unnecessary process, and then, the measurement and/or the evaluation corresponding to the second condition-based mobility configuration may be stopped, so as to avoid unnecessary operations.

It should be noted that, in some embodiments of the present disclosure, the foregoing “the execution condition of the first condition-based mobility configuration being not satisfied” may be understood as that all events corresponding to the execution condition of the first condition-based mobility configuration are not satisfied.

For example, if the execution condition of the first condition-based mobility configuration corresponds to the event 1, when the event 1 is not satisfied, it is considered that the execution condition of the first condition-based mobility configuration is not satisfied. In some embodiments, if the execution condition of the first condition-based mobility configuration corresponds to the event 1 and the event 2, when neither the event 1 nor the event 2 is satisfied, it is considered that the execution condition of the first condition-based mobility configuration is not satisfied.

In addition, for other detailed descriptions of step 801, reference may be made to descriptions of the foregoing embodiments.

In summary, in the method for measurement provided in the embodiments of the present disclosure, in response to the execution condition of the first condition-based mobility configuration being not satisfied, the terminal may stop the measurement and/or the evaluation corresponding to the second condition-based mobility configuration. In this way, some unnecessary measurements may be stopped in time, thus avoiding unnecessary operations.

FIG. 9 is a schematic flowchart of a method for measurement provided according to some embodiments of the present disclosure. The method is performed by a terminal. As shown in FIG. 9, the method for measurement may include the following step.

In step 901, in response to any event corresponding to an execution condition of a first condition-based mobility configuration being not satisfied, a measurement and/or an evaluation corresponding to an associated second condition-based mobility configuration are stopped.

In some embodiments of the present disclosure, in the previous step, if it is measured that any event corresponding to the execution condition of the first condition-based mobility configuration is satisfied, the measurement and/or the evaluation corresponding to the second condition-based mobility configuration are initiated. In this case, in the process of initiating the measurement and/or the evaluation corresponding to the second condition-based mobility configuration, the measurement and/or the evaluation corresponding to other events corresponding to the execution condition of the first condition-based mobility configuration are also synchronously performed. If it is measured that other events are not satisfied, it indicates that the execution condition of the first condition-based mobility configuration is not satisfied. Similarly, in this case, “the process of the measurement and/or the evaluation corresponding to the second condition-based mobility configuration” becomes a meaningless unnecessary process, and the measurement and/or the evaluation corresponding to the second condition-based mobility configuration may be stopped, so as to avoid unnecessary operations.

For example, in some embodiments of the present disclosure, it is assumed that the network device configures the first condition-based mobility configuration #1 and the second condition-based mobility configuration #2 associated with the first condition-based mobility configuration #1 to the terminal, where the execution condition of the first condition-based mobility configuration #1 corresponds to the event 1 and the event 2. When the terminal initiates the measurement and/or the evaluation corresponding to the first condition-based mobility configuration #1, if the terminal first measures the event 1, and the terminal measures that the event 1 is satisfied, the terminal may initiate the measurement and/or the evaluation corresponding to the second condition-based mobility configuration #2. Meanwhile, the terminal may also synchronously measure whether the event 2 is satisfied; and if the terminal measures that the event 2 is not satisfied, the terminal may then stop the measurement and/or the evaluation corresponding to the second condition-based mobility configuration #2.

For other detailed descriptions of step 901, reference may be made to the description of the foregoing embodiments.

In summary, in the method for measurement provided in the embodiments of the present disclosure, in response to any event corresponding to the execution condition of the first condition-based mobility configuration being not satisfied, the terminal may stop the measurement and/or the evaluation corresponding to the second condition-based mobility configuration. In this way, some unnecessary measurements may be stopped in time, thus avoiding unnecessary operations.

FIG. 10 is a schematic flowchart of a method for measurement provided according to some embodiments of the present disclosure. The method is performed by a terminal. As shown in FIG. 10, the method for measurement may include the following step:
In step 1001, according to a measurement result and/or an evaluation result of an execution condition of a first condition-based mobility configuration, it is determined whether the execution condition of the first condition-based mobility configuration is satisfied.

It should be noted that, in some embodiments of the present disclosure, the measurement result and/or the evaluation result of the execution condition may include a measurement result and/or an evaluation result corresponding to the event of the execution condition, and determining whether the execution condition is satisfied based on the measurement result and/or the evaluation result of the execution condition may include: determining whether the event is satisfied based on the measurement result and/or the evaluation result corresponding to each event, and determining that the execution condition is satisfied when all events are satisfied.

For other detailed descriptions of “the measurement result and/or the evaluation result” and “how to determine, based on the measurement result and/or the evaluation result, whether the execution condition is satisfied” in step 1001, reference may be made to the embodiment corresponding to FIG. 2a.

In summary, in the method for measurement provided in the embodiments of the present disclosure, the terminal device may determine, based on the measurement result and/or the evaluation result of the execution condition of the first condition-based mobility configuration, whether the execution condition of the first condition-based mobility configuration is satisfied. It can be seen from this that the present disclosure provides a method for determining whether an execution condition is satisfied; and in the present disclosure, the terminal device correspondingly determines, based on the measurement result and/or the evaluation result of the execution condition, whether the execution condition is satisfied, thus the accuracy is relatively higher.

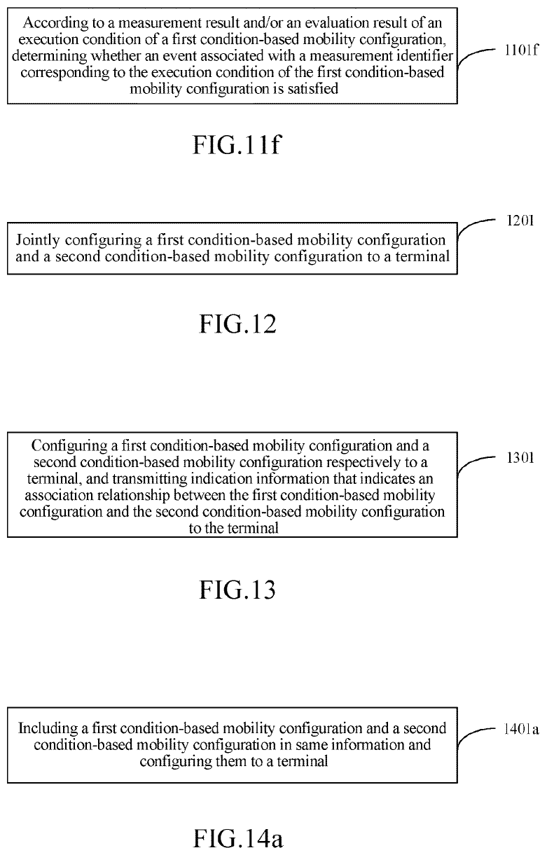

FIG. 11a is a schematic flowchart of a method for measurement provided according to some embodiments of the present disclosure. The method is performed by a terminal. As shown in FIG. 11a, the method for measurement may include the following step.

In step 1101a, according to a measurement result and/or an evaluation result of an execution condition of a first condition-based mobility configuration, it is determined whether an event corresponding to the execution condition of the first condition-based mobility configuration is satisfied.

It should be noted that, in some embodiments of the present disclosure, the measurement result and/or the evaluation result of the execution condition may include a measurement result and/or an evaluation result corresponding to the event of the execution condition. And, determining, based on the measurement result and/or the evaluation result of the execution condition, whether the event corresponding to the execution condition is satisfied, may include: determining, based on the measurement result and/or the evaluation result corresponding to each event, whether the event is satisfied.

For other detailed descriptions of “the measurement result and/or the evaluation result” and “how to determine, based on the measurement result and/or the evaluation result, whether the event is satisfied” in step 1101a, reference may be made to the embodiment corresponding to FIG. 2a.

In summary, in the method for measurement provided in the embodiments of the present disclosure, the terminal device may determine, according to the measurement result and/or the evaluation result of the execution condition of the first condition-based mobility configuration, whether an event corresponding to the execution condition of the first condition-based mobility configuration is satisfied. It can be seen from this that the present disclosure provides a method for determining whether an event is satisfied, and in the present disclosure, the terminal device determines, based on the measurement result and/or the evaluation result of the execution condition, whether the event corresponding to the execution condition is satisfied, thus the accuracy is relatively higher.

FIG. 11b is a schematic flowchart of a method for measurement provided according to some embodiments of the present disclosure. The method is performed by a terminal. As shown in FIG. 11b, the method for measurement may include the following step.

In step 1101b, in response to an event associated with each measurement identifier corresponding to an execution condition of a first condition-based mobility configuration being satisfied, a measurement and/or an evaluation corresponding to an associated second condition-based mobility configuration are initiated.

In some embodiments of the present disclosure, the execution condition may correspond to at least one event, each event may be associated with a measurement identifier, and the measurement identifier is at least used to determine a measurement content. The measurement content is used to indicate a measurement to be performed by the terminal. The measurement content may include, for example, measurement of an RSRP of an uplink signal of the measurement terminal and/or RSRQ of the uplink signal, or the like. In some embodiments, the terminal may perform corresponding measurement on the associated candidate cell based on the measurement identifier and obtain a measurement result. Then, the terminal may evaluate, according to the measurement result, whether the event associated with the measurement identifier is satisfied, and obtain an evaluation result. The evaluation result may be that the event is satisfied or the event is not satisfied. When it is determined that all events are satisfied, it is determined that the execution condition is satisfied; otherwise, it is determined that the execution condition is not satisfied. In some embodiments, when it is determined that the execution condition of the condition-based mobility configuration is satisfied, corresponding mobility management may be performed on the candidate cell associated with the condition-based mobility configuration.

In addition, for other detailed descriptions of step 1101b, reference may be made to the embodiment corresponding to FIG. 2a.

In summary, in the method for measurement provided in the embodiments of the present disclosure, in response to the event associated with each measurement identifier corresponding to the execution condition of the first condition-based mobility configuration being satisfied, the terminal may initiate the measurement and/or the evaluation corresponding to the second condition-based mobility configuration. It can be seen from this that, in the present disclosure, it is determined, based on whether the event associated with the measurement identifier is satisfied, whether to initiate the measurement and/or the evaluation corresponding to the second condition-based mobility configuration. In some embodiments, since each event and the measurement identifier are associated with each other, when it is determined whether the event associated with the measurement identifier is satisfied, it is organized relatively well, thus avoiding the situation of disordered measurements, and ensuring the measurement accuracy.

FIG. 11c is a schematic flowchart of a method for measurement according to some embodiments of the present disclosure. The method is performed by a terminal. As shown in FIG. 11c, the method for measurement may include the following step.

In step 1101c, in response to an event associated with any measurement identifier corresponding to an execution condition of a first condition-based mobility configuration being satisfied, a measurement and/or an evaluation corresponding to an associated second condition-based mobility configuration are initiated.

For detailed descriptions of step 1101c, reference may be made to the description of the foregoing embodiments. For detailed descriptions of “the event associated with the measurement identifier” and “how to determine whether the event associated with the measurement identifier being satisfied” in step 1101c, reference may be made to the content in the embodiment in FIG. 2a or FIG. 11b.

In summary, in the method for measurement provided in the embodiments of the present disclosure, in response to an event associated with any measurement identifier corresponding to the execution condition of the first condition-based mobility configuration being satisfied, the terminal may initiate the measurement and/or the evaluation corresponding to the second condition-based mobility configuration. It can be seen from this that, in the present disclosure, it is determined, based on whether the event associated with the measurement identifier is satisfied, whether to initiate the measurement and/or the evaluation corresponding to the second condition-based mobility configuration. In some embodiments, since each event and the measurement identifier are associated with each other, when it is determined whether the event associated with the measurement identifier is satisfied, it is organized relatively well, thus avoiding the situation of disordered measurements, and ensuring the measurement accuracy.

FIG. 11d is a schematic flowchart of a method for measurement provided according to some embodiments of the present disclosure. The method is performed by a terminal. As shown in FIG. 11d, the method for measurement may include the following step.

In step 1101d, in response to no event associated with each measurement identifier corresponding to an execution condition of a first condition-based mobility configuration being satisfied, a measurement and/or an evaluation corresponding to an associated second condition-based mobility configuration are stopped.

For detailed descriptions of step 1101d, reference may be made to the description of the foregoing embodiments. For detailed descriptions of “the event associated with the measurement identifier” and “how to determine whether the event associated with the measurement identifier is satisfied” in step 1101d, reference may be made to the content in the embodiment in FIG. 2a or FIG. 11b.

In summary, in the method for measurement provided in the embodiments of the present disclosure, in response to no event associated with each measurement identifier corresponding to the execution condition of the first condition-based mobility configuration being satisfied, the terminal may stop the measurement and/or the evaluation corresponding to the second condition-based mobility configuration. It can be seen from this that, in the present disclosure, it is determined, based on whether the event associated with the measurement identifier is satisfied, whether to stop the measurement and/or the evaluation corresponding to the second condition-based mobility configuration. In some embodiments, since each event and the measurement identifier are associated with each other, when it is determined whether the event associated with the measurement identifier is satisfied, it is organized relatively well, thus avoiding the situation of disordered measurements, and ensuring the measurement accuracy.

FIG. 11eis a schematic flowchart of a method for measurement provided according to some embodiments of the present disclosure. The method is performed by a terminal. As shown in FIG. 11e, the method for measurement may include the following step.

In step 1101e, in response to an event associated with any measurement identifier corresponding to an execution condition of a first condition-based mobility configuration being not satisfied, a measurement and/or an evaluation corresponding to an associated second condition-based mobility configuration are stopped.

For detailed descriptions of step 1101e, reference may be made to the description of the foregoing embodiments. For detailed descriptions of “the event associated with the measurement identifier” and “how to determine whether the event associated with the measurement identifier is satisfied” in step 1101e, reference may be made to the content in the embodiment in FIG. 2a or FIG. 11b.

In summary, in the method for measurement provided in the embodiments of the present disclosure, in response to the event associated with any measurement identifier corresponding to the execution condition of the first condition-based mobility configuration being not satisfied, the terminal may stop the measurement and/or the evaluation corresponding to the second condition-based mobility configuration. It can be seen from this that, in the present disclosure, it is determined, based on whether the event associated with the measurement identifier is satisfied, whether to stop the measurement and/or the evaluation corresponding to the second condition-based mobility configuration. In some embodiments, since each event and the measurement identifier are associated with each other, when it is determined whether the event associated with the measurement identifier is satisfied, it is organized relatively well, thus avoiding the situation of disordered measurements, and ensuring the measurement accuracy.

FIG. 11f is a schematic flowchart of a method for measurement provided according to some embodiments of the present disclosure. The method is performed by a terminal. As shown in FIG. 11f, the method for measurement may include the following step.

In step 1101f, according to a measurement result and/or an evaluation result of an execution condition of a first condition-based mobility configuration, it is determined whether an event associated with a measurement identifier corresponding to the execution condition of the first condition-based mobility configuration is satisfied.

It should be noted that, in some embodiments of the present disclosure, the measurement result and/or the evaluation result of the execution condition may include a measurement result and/or an evaluation result corresponding to the measurement identifier of the execution condition.

For other detailed descriptions of step 1101f, reference may be made to the description of the foregoing embodiments.

In summary, in the method for measurement provided in the embodiments of the present disclosure, the terminal may determine, according to the measurement result and/or the evaluation result of the execution condition of the first condition-based mobility configuration, whether the event associated with the measurement identifier corresponding to the execution condition of the first condition-based mobility configuration is satisfied. In some embodiments, since there is at least one event corresponding to the execution condition, and each event is associated with the measurement identifier, there is an association relationship between the execution condition, the event, and the measurement identifier. On this basis, when the terminal determines, based on the measurement result and/or the evaluation result of the execution condition, whether the event associated with each measurement identifier is satisfied, the accuracy is relatively high, and it may be ensured that it is organized well during measurement, thus avoiding the situation of disordered measurements.

FIG. 12 is a schematic flowchart of a method for measurement provided according to some embodiments of the present disclosure. The method is performed by a network device. As shown in FIG. 12, the method for measurement may include the following step.

In step 1201, a first condition-based mobility configuration and a second condition-based mobility configuration are jointly configured to a terminal.

For detailed descriptions of step 1201, reference may be made to the description of the foregoing embodiments.

In summary, in the method for measurement provided in the embodiments of the present disclosure, the network device may jointly configure the first condition-based mobility configuration and the second condition-based mobility configuration to the terminal, so that the terminal initiates the measurement and/or the evaluation corresponding to the first condition-based mobility configuration, and initiates the measurement and/or the evaluation corresponding to the second condition-based mobility configuration based on the measurement result and/or the evaluation result corresponding to the first condition-based mobility configuration. Compared with simultaneously initiating all of the measurement and/or the evaluation corresponding to the first condition-based mobility configuration and the measurement and/or the evaluation corresponding to the second condition-based mobility configuration, the measurement frequency and the required measurement amount may be effectively reduced in the present disclosure, thus reducing the additional power consumption of the terminal, and improving the execution efficiency of mobility management.

FIG. 13 is a schematic flowchart of a method for measurement provided according to some embodiments of the present disclosure. The method is performed by a network device. As shown in FIG. 13, the method for measurement may include the following step.

In step 1301, a first condition-based mobility configuration and a second condition-based mobility configuration are configured to the terminal respectively, and indication information that indicates an association relationship between the first condition-based mobility configuration and the second condition-based mobility configuration are transmitted to the terminal.

In summary, in the method for measurement provided in the embodiments of the present disclosure, the network device configures the first condition-based mobility configuration and the second condition-based mobility configuration respectively to the terminal, and transmits indication information that indicates an association relationship between the first condition-based mobility configuration and the second condition-based mobility configuration to the terminal. Thus, the present disclosure provides a joint configuration method used for jointly configuring a first condition-based mobility configuration and a second condition-based mobility configuration.

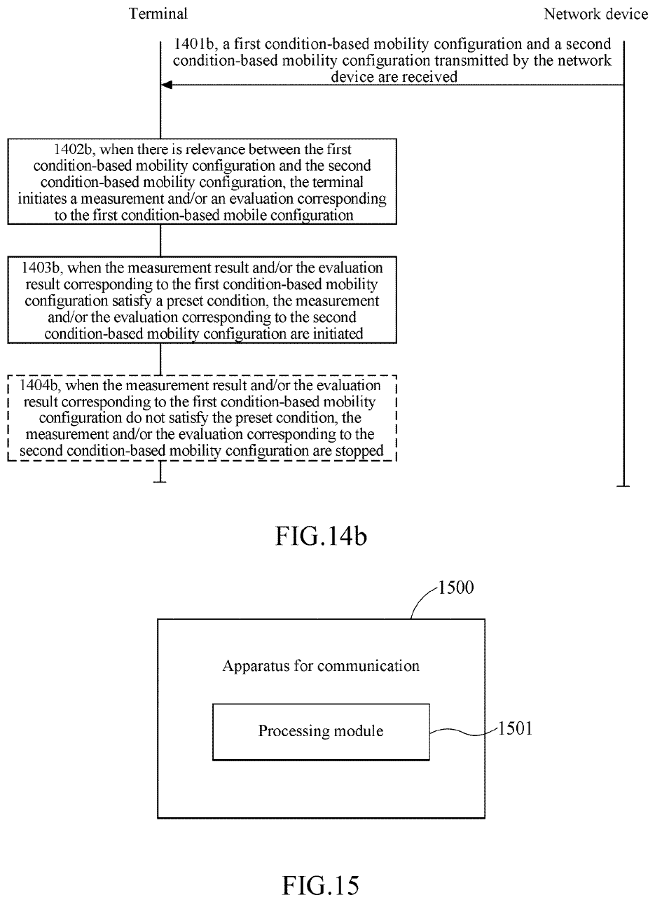

FIG. 14a is a schematic flowchart of a method for measurement provided according to some embodiments of the present disclosure, and the method is performed by a network device. As shown in FIG. 14a, the method for measurement may include the following step.

In step 1401a, a first condition-based mobility configuration and a second condition-based mobility configuration are included in same information and configured to a terminal.

In summary, in the method for measurement provided in the embodiments of the present disclosure, the first condition-based mobility configuration and the second condition-based mobility configuration are included in the same information and configured to the terminal by the network device. It can be seen from this that, the present disclosure provides a joint configuration method used for jointly configuring a first condition-based mobility configuration and a second condition-based mobility configuration. In addition, in the method of the present disclosure, joint configuration is implemented by “including the first condition-based mobility configuration and the second condition-based mobility configuration in the same information”, without transmitting other additional information, thus reducing the signaling overhead.

Examples of the method of the present disclosure are further described below.

In some embodiments of the present disclosure, for an existing joint configuration of CHO and CPAC of the UE (that is, the foregoing terminal), the UE first initiates the measurement required for evaluating the execution condition of the CHO, and determines, according to the satisfaction of the event of the CHO, whether to start/stop the measurement corresponding to the condition of the CPAC.

In some embodiments of the present disclosure, when the execution condition of the CHO is satisfied, a measurement corresponding to the execution condition of the CPAC associated with the CHO is initiated.

In some embodiments of the present disclosure, when the execution condition of the CHO is not satisfied, the measurement corresponding to the execution condition of the CPAC associated with the CHO is stopped.

In some embodiments of the present disclosure, 1), when the UE receives the configuration information of conditional reconfiguration, and the condition reconfiguration configuration includes the configurations of the CHO and the CPA/CPC, there is a correspondence among the configurations of the CHO and the CPA/CPC, which is used to configure the CHO and CPA/CPC configurations that may be performed simultaneously.

In some embodiments of the present disclosure, 2), when the UE receives the configuration information of conditional reconfiguration transmitted by the network side, the UE stores the configuration information of conditional reconfiguration, and performs corresponding measurement according to the stored configuration of conditional reconfiguration.

In some embodiments of the present disclosure, 3), when the UE receives the joint configuration of CHO and CPA/CPC, the UE first initiates the measurement required for evaluating the execution condition of the CHO. When the execution condition of the CHO is satisfied or is partially satisfied, the UE initiates the measurement of the execution condition of the CPA/CPC jointly configured by the UE.

In some embodiments of the present disclosure, 4), based on 1) to 3), for the condition reconfiguration configuration stored by the UE, the UE initiates a measurement corresponding to the existing CHO.

In some embodiments of the present disclosure, 4.1), for each measurement identifier configured for the UE, if the associated report configuration is a conditional trigger configuration, and the measurement identifier is one of the measurement identifiers corresponding to the CHO, a corresponding measurement is initiated.

In some embodiments of the present disclosure, for example, if the reportType of the associated reportConfig is condTriggerConfig, the measId is indicated in condExecutionCond or condExecutionCondSCG associated with condReconfigId in VarConditionalReconfig, and masterCellGroup including reconfiguration WithSync and associated with condReconfigId is included in condRRCReconfig, a corresponding measurement is initiated.

In some embodiments of the present disclosure, 5), based on 1) to 3), for a condition reconfiguration configuration stored by the UE, the UE initiates the measurement corresponding to the execution condition of the CPA/CPC when one or more of the following situations are satisfied.

In some embodiments of the present disclosure, 5.1), the execution condition of the CHO jointly configured with the CPA/CPC is satisfied.

In some embodiments of the present disclosure, 5.2), any event corresponding to the execution condition of the CHO jointly configured with the CPA/CPC is satisfied.

In some embodiments of the present disclosure, 5.3), any event corresponding to the execution condition of the CHO jointly configured with the CPA/CPC satisfies an entry condition.

In some embodiments of the present disclosure, 6), based on 1) to 3), when the UE initiates the measurement corresponding to the CPA/CPC, the UE stops the measurement corresponding to the CPA/CPC execution condition when one or more of the following situations are satisfied.

In some embodiments of the present disclosure, 6.1), the execution condition of the CHO jointly configured with the CPA/CPC is not satisfied.

In some embodiments of the present disclosure, 6.2), any event corresponding to the execution condition of the CHO jointly configured with the CPA/CPC is not satisfied.

In some embodiments of the present disclosure, 6.3), any event corresponding to the execution condition of the CHO jointly configured with the CPA/CPC satisfies a leaving condition.

In some embodiments of the present disclosure, 7), the measurement corresponding to the execution condition of the CHO (or CPA/CPC) in 1) to 6) refers to a measurement corresponding to one or more measurement identifiers (measId) corresponding to the execution condition of the CHO (or CPA/CPC). A measurement result of the candidate PCell/PSCell corresponding to the candidate is obtained by performing this measurement. Then, it is determined, according to the measurement result, whether the conditional trigger event associated with the measId is satisfied. The execution condition is satisfied only when all conditional trigger events corresponding to the execution condition of the CHO (or CPA/CPC) are satisfied.

In some embodiments of the present disclosure, 8), the joint configuration of CHO and CPA/CPC in 1) may be indicated by using displayed indication information, or may be configured by including the configuration of the CHO and the CPA/CPC in same information.

FIG. 14b is a schematic flowchart of another method for measurement provided according to the present disclosure.

In step 1401b, the terminal receives a first condition-based mobility configuration and a second condition-based mobility configuration transmitted by the network device.

In some embodiments, the first condition-based mobility configuration may be a CHO configuration or a CPAC configuration, where the CPAC configuration may be a CPA configuration or a CPC configuration. The second condition-based mobility configuration may also be a CHO configuration or a CPAC configuration, where the CPAC configuration may be a CPA configuration or a CPC configuration. Moreover, the first condition-based mobility configuration is different from the second condition-based mobility configuration. In an example, the first condition-based mobility configuration is specifically a CHO configuration; and, the second condition-based mobility configuration is a CPAC configuration, and more specifically, the second condition-based mobility configuration is a CPA configuration or a CPC configuration. In another example, the first condition-based mobility configuration is a CPAC configuration, and more specifically, the first condition-based mobility configuration is a CPA configuration or a CPC configuration; and, the second condition-based mobility configuration is specifically a CHO Configuration.

In some embodiments, the first condition-based mobility configuration and the second condition-based mobility configuration may be carried in one or more messages transmitted by the network device to the terminal. In an example, the first condition-based mobility configuration and the second condition-based mobility configuration may be carried in one or more RRC reconfiguration messages transmitted by the network device to the terminal.

It should be noted that naming of the RRC reconfiguration message in each access mode is different. For example, in E-UTRA, the RRC reconfiguration message is RRC Connection Reconfiguration. In NR, the RRC reconfiguration message is RRC Reconfiguration. For ease of description, in the embodiments of the present disclosure, the message used for RRC reconfiguration is collectively referred to as an RRC reconfiguration message. In future communication development, the message used for RRC reconfiguration may be given another name, such as B. It should understand that, if B may also implement the function implemented by the RRC reconfiguration message in the embodiments of the present disclosure, B may also be understood as the RRC reconfiguration message in the embodiments of the present disclosure.

In step 1402b, the terminal initiates a measurement and/or an evaluation corresponding to the first condition-based mobile configuration.

In some embodiments, the first condition-based mobility configuration includes an execution condition (which may also be referred to as a trigger condition), related information of the candidate cell, or the like. In some embodiments, the execution condition may include one or more events. In an example, each event in the execution condition corresponds to a measurement identifier, and each measurement identifier corresponds to a measurement object, that is, each measurement identifier corresponds to a configuration of a measurement target. In some embodiments, initiating the measurement and/or the evaluation corresponding to the first condition-based mobile configuration includes performing measurement on the measurement object corresponding to the measurement identifier, and/or performing evaluation on the measurement result.

In step 1403b, for the second condition-based mobility configuration associated with the first condition-based mobility configuration, when the measurement result and/or the evaluation result corresponding to the first condition-based mobility configuration satisfy a preset condition, the measurement and/or the evaluation corresponding to the second condition-based mobility configuration are initiated.

In some embodiments, when the first condition-based mobility configuration and the second condition-based mobility configuration satisfy one of the following conditions, there is relevance between the first condition-based mobility configuration and the second condition-based mobility configuration.
1) The first condition-based mobility configuration and the second condition-based mobility configuration are carried in the same message transmitted by the network device to the terminal.
2) The first condition-based mobility configuration and the second condition-based mobility configuration are carried in a plurality of messages in the same procedure transmitted by the network device to the terminal.
3) The first condition-based mobility configuration and the second condition-based mobility configuration are configured in different messages, however, the network device further transmits indication information to the terminal, where the indication information is used to indicate that there is relevance between the first condition-based mobility configuration and the second condition-based mobility configuration.

It should be noted that, several cases in which there is relevance between the first condition-based mobile configuration and the second condition-based mobile configuration, are merely exemplarily illustrated above. The specific case in which there is relevance between the first condition-based mobile configuration and the second condition-based mobile configuration, is not specifically limited in the present disclosure.

In some embodiments, the first condition-based mobility configuration includes an execution condition (which may also be referred to as a trigger condition), related information of the candidate cell, or the like. In some embodiments, the execution condition may include one or more events. In an example, the candidate cell included in the first condition-based mobility configuration may be considered as a candidate cell associated with the first condition-based mobility configuration. In another example, each event in the execution condition corresponds to a measurement identifier, and each measurement identifier corresponds to a measurement object, that is, each measurement identifier corresponds to a configuration of a measurement target.

In some embodiments, when it is determined, based on the measurement result and/or the evaluation result corresponding to the first condition-based mobility configuration, that the execution condition of the first condition-based mobility configuration is satisfied, the measurement and/or the evaluation corresponding to the second condition-based mobility configuration is initiated. In an example, the execution condition of the first condition-based mobility configuration being satisfied includes that all events in the execution condition of the first condition-based mobility configuration are satisfied.

In some embodiments, when it is determined, based on the measurement result and/or the evaluation result corresponding to the first condition-based mobility configuration, that at least one event in the execution condition of the first condition-based mobility configuration is satisfied, the measurement and/or the evaluation corresponding to the second condition-based mobility configuration are initiated.

In some embodiments, when the measurement result and/or the evaluation result corresponding to the first condition-based mobility configuration do not satisfy the preset condition, it is determined that the measurement and/or the evaluation corresponding to the second condition-based mobility configuration are not initiated.

For other content involved in the process shown in FIG. 14b, reference may be made to descriptions of related content in the foregoing other embodiments, and details are not described here again.

According to another schematic flowchart of a method for measurement provided in the present disclosure, the method includes the following step.

In step 1404b, for the second condition-based mobility configuration associated with the first condition-based mobility configuration, when the measurement result and/or the evaluation result corresponding to the first condition-based mobility configuration do not satisfy the preset condition, the measurement and/or the evaluation corresponding to the second condition-based mobility configuration are stopped.

In some embodiments, after step 1403b is performed, that is, after the measurement and/or the evaluation corresponding to the second condition-based mobile configuration are initiated, the measurement and/or the evaluation corresponding to the first condition-based mobile configuration are continuously performed. When the measurement result and/or the evaluation result corresponding to the first condition-based mobility configuration do not satisfy the preset condition, the measurement and/or the evaluation corresponding to the second condition-based mobility configuration are stopped.

In some embodiments, the foregoing step 1401b to step 1403b may not be performed, and the terminal initiates the measurement and/or the evaluation corresponding to the second condition-based mobile configuration by using another method. The terminal also performs the measurement and/or the evaluation corresponding to the first condition-based mobility configuration. When the measurement result and/or the evaluation result corresponding to the first condition-based mobility configuration do not satisfy the preset condition, the measurement and/or the evaluation corresponding to the second condition-based mobility configuration are stopped.

FIG. 15 is a schematic structural diagram of an apparatus for communication 1500 provided according to some embodiments of the present disclosure. As shown in FIG. 15, the apparatus may include a processing module 1501.

The processing module is configured to, in response to a first condition-based mobility configuration and a second condition-based mobility configuration being jointly configured, initiate a measurement and/or an evaluation corresponding to the first condition-based mobility configuration.

In summary, in the apparatus for communication provided in the embodiments of the present disclosure, in response to the first condition-based mobility configuration and the second condition-based mobility configuration being jointly configured, the terminal may initiate the measurement and/or the evaluation corresponding to the first condition-based mobility configuration; and then, the terminal may initiate the measurement and/or the evaluation corresponding to the second condition-based mobility configuration based on the measurement result and/or the evaluation result corresponding to the first condition-based mobility configuration. Compared with simultaneously initiating all of the measurement and/or the evaluation corresponding to the first condition-based mobility configurations and the measurement and/or the evaluation corresponding to the second condition-based mobility configuration, the measurement frequency and the required number of measurements may be effectively reduced in the present disclosure, thus reducing the additional power consumption of the terminal, and improving the execution efficiency of mobility management.

In some embodiments of the present disclosure, the processing module is further configured to:
initiate a measurement and/or an evaluation corresponding to the second condition-based mobility configuration based on a measurement result and/or an evaluation result corresponding to the first condition-based mobility configuration.

In some embodiments of the present disclosure, the first condition-based mobility configuration includes a conditional handover (CHO) configuration, and the second condition-based mobility configuration includes a conditional primary secondary cell addition (CPA) configuration or a conditional primary secondary cell change (CPC) configuration.

In some embodiments, the first condition-based mobility configuration includes a CPA configuration or a CPC configuration, and the second condition-based mobility configuration includes a CHO configuration.

In some embodiments of the present disclosure, the apparatus is further configured to:
in response to receiving indication information that indicates an association relationship between the first condition-based mobility configuration and the second condition-based mobility configuration, determine that the first condition-based mobility configuration and the second condition-based mobility configuration are jointly configured.

In some embodiments of the present disclosure, the apparatus is further configured to:
in response to the first condition-based mobility configuration and the second condition-based mobility configuration being included in same information and configured to the terminal, determine that the first condition-based mobility configuration and the second condition-based mobility configuration are jointly configured.

In some embodiments of the present disclosure, the processing module is further configured to:
initiate a measurement and/or an evaluation corresponding to at least one event corresponding to the execution condition of the first condition-based mobility configuration.

In some embodiments of the present disclosure, the processing module is further configured for any one or more of the following:
in response to an execution condition of the first condition-based mobility configuration being satisfied, initiating the measurement and/or the evaluation corresponding to the associated second condition-based mobility configuration; and
in response to any event corresponding to an execution condition of the first condition-based mobility configuration being satisfied, initiating the measurement and/or the evaluation corresponding to the associated second condition-based mobility configuration.

In some embodiments of the present disclosure, the apparatus is further configured to:
stop the measurement and/or the evaluation corresponding to the associated second condition-based mobility configuration based on the measurement result and/or the evaluation result corresponding to the first condition-based mobility configuration.

In some embodiments of the present disclosure, the apparatus is further configured for any one or more of the following:
in response to the execution condition of the first condition-based mobility configuration being not satisfied, stopping the measurement and/or the evaluation corresponding to the associated second condition-based mobility configuration; and
in response to any event corresponding to the execution condition of the first condition-based mobility configuration being not satisfied, stopping the measurement and/or the evaluation corresponding to the associated second condition-based mobility configuration.

In some embodiments of the present disclosure, the apparatus is further configured for any one or more of the following:
according to the measurement result and/or the evaluation result of the execution condition of the first condition-based mobility configuration, determining whether the execution condition of the first condition-based mobility configuration is satisfied; and
according to the measurement result and/or the evaluation result of the execution condition of the first condition-based mobility configuration, determining whether an event corresponding to the execution condition of the first condition-based mobility configuration is satisfied.

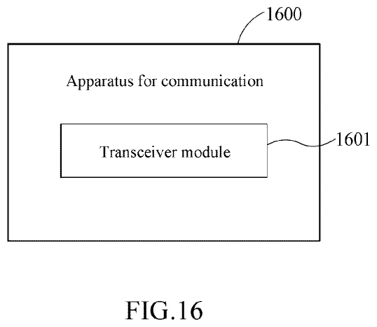

FIG. 16 is a schematic structural diagram of an apparatus for communication 1600 provided according to some embodiments of the present disclosure. As shown in FIG. 16, the apparatus may include a transceiver module 1601.

The transceiver module is configured to jointly configure a first condition-based mobility configuration and a second condition-based mobility configuration to a terminal.

In summary, in the apparatus for communication provided in the embodiments of the present disclosure, the network device may jointly configure the first condition-based mobility configuration and the second condition-based mobility configuration to the terminal, so that the terminal initiates the measurement and/or the evaluation corresponding to the first condition-based mobility configuration, and initiates the measurement and/or the evaluation corresponding to the second condition-based mobility configuration based on the measurement result and/or the evaluation result corresponding to the first condition-based mobility configuration. Compared with simultaneously initiating all of the measurement and/or the evaluation corresponding to the first condition-based mobility configurations and the measurement and/or the evaluation corresponding to the second condition-based mobility configuration, the measurement frequency and the required number of measurements may be effectively reduced in the present disclosure, thus reducing the additional power consumption of the terminal, and improving the execution efficiency of mobility management.

In some embodiments of the present disclosure, the first condition-based mobility configuration includes a CHO configuration, and the second condition-based mobility configuration includes a CPA configuration or a CPC configuration.

In some embodiments, the first condition-based mobility configuration includes a CPA configuration or a CPC configuration, and the second condition-based mobility configuration includes a CHO configuration.

In some embodiments of the present disclosure, the transceiver module is further configured to:
configure the first condition-based mobility configuration and the second condition-based mobility configuration respectively to the terminal, and transmit indication information that indicates an association relationship between the first condition-based mobility configuration and the second condition-based mobility configuration to the terminal.

In some embodiments of the present disclosure, the transceiver module is further configured to:
configure the first condition-based mobility configuration and the second condition-based mobility configuration to the terminal by comprising the first condition-based mobility configuration and the second condition-based mobility configuration in same information.

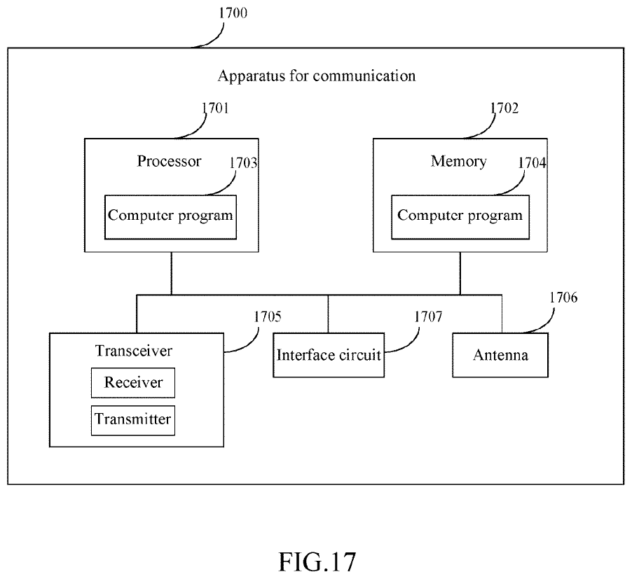

Referring to FIG. 17, FIG. 17 is a schematic structural diagram of an apparatus for communication 1700 provided according to some embodiments of the present disclosure. The apparatus for communication 1700 may be a network device, or a terminal. The apparatus may also be a chip, a chip system, or a processor that supports the network device to implement the foregoing method, or the like. The apparatus may also be a chip, a chip system, or a processor that supports the terminal to implement the foregoing method, or the like. The apparatus may be configured to implement the method described in the foregoing method embodiments. For details, reference may be made to the descriptions in the foregoing method embodiments.

The apparatus for communication 1700 may include one or more processors 1701, and the processor 1701 may be a general-purpose processor or a dedicated processor. For example, the processor 1701 may be a baseband processor or a central processing unit. The baseband processor may be configured to process a communication protocol and communication data, and the central processing unit may be configured to control the apparatus for communication (for example, a base station, a baseband chip, a terminal, a terminal chip, a DU, or a CU), execute a computer program, and process data of the computer program.

In some embodiments, the apparatus for communication 1700 may further include one or more memories 1702. A computer program 1704 may be stored on the memory 1702. The processor 1701 executes the computer program 1704, so that the apparatus for communication 1700 performs the method described in the foregoing method embodiments. In some embodiments, the memory 1702 may further store data. The apparatus for communication 1700 and the memory 1702 may be separately disposed, or may be integrated together.

In some embodiments, the apparatus for communication 1700 may further include a transceiver 1705 and an antenna 1706. The transceiver 1705 may be referred to as a transceiver unit, a transceiver machine, a transceiver circuit, or the like, and is configured to implement a transceiver function. The transceiver 1705 may include a receiver and a transmitter. The receiver may be referred to as a receiving machine or a receiving circuit, and is configured to implement a receiving function. The transmitter may be referred to as a transmitting machine or a transmitting circuit, and is configured to implement a transmitting function.

In some embodiments, the apparatus for communication 1700 may further include one or more interface circuits 1707, and the interface circuit 1707 is configured to receive a code instruction and transmit the code instruction to the processor 1701. The processor 1701 runs the code instruction, so that the apparatus for communication 1700 performs the method described in the foregoing method embodiments.

In some embodiments, the processor 1701 may include a transceiver configured to implement a receiving and transmitting function. For example, the transceiver may be a transceiver circuit, an interface, or an interface circuit. The transceiver circuit, the interface, or the interface circuit configured to implement the receiving and transmitting function may be separate, or may be integrated together. The transceiver circuit, the interface, or the interface circuit may be configured to read/write code/data. In some embodiments, the transceiver circuit, the interface, or the interface circuit may be configured to transmit or delivery a signal.

In some embodiments, the processor 1701 may store a computer program 1703. The computer program 1703 runs on the processor 1701, so that the apparatus for communication 1700 may perform the method described in the foregoing method embodiments. The computer program 1703 may be cured in the processor 1701. In this case, the processor 1701 may be implemented by hardware.

In some embodiments, the apparatus for communication 1700 may include a circuit, and the circuit may implement a function of transmitting or receiving or communicating in the foregoing method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, or the like. The processor and the transceiver may also be fabricated by using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), or the like.

The apparatus for communication in the foregoing embodiments may be a network device or a terminal, but the scope of the apparatus for communication described in the present disclosure is not limited to this. In addition, the structure of the apparatus for communication may not be limited by FIG. 17. The apparatus for communication may be a standalone device or may be part of a larger device. For example, the apparatus for communication may be:
(1) an independent integrated circuit (IC), or a chip, or a chip system or subsystem;
(2) a set having one or more ICs, in some embodiments, the IC set may also include a storage component for storing data and a computer program;
(3) an ASIC, such as a modem;
(4) a module that may be embedded in other devices;
(5) a receiver, a terminal, a smart terminal, a cellular phone, a wireless device, a handset, a mobile unit, a vehicle-mounted device, a network device, a cloud device, an artificial intelligence device, or the like;
(6) another device, etc.

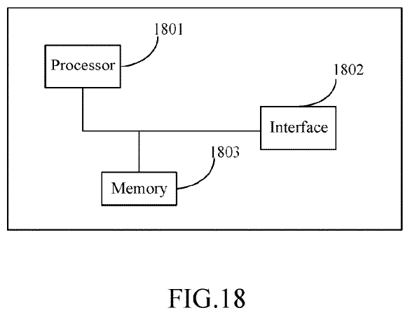

For a case that the apparatus for communication may be a chip or a chip system, reference may be made to the schematic structural diagram of the chip shown in FIG. 18. The chip shown in FIG. 18 includes a processor 1801 and an interface 1802, where the number of the processor 1801 may be one or more, and the number of the interface 1802 may be more than one.

In some embodiments, the chip further includes a memory 1803, and the memory 1803 is configured to store necessary computer programs and data.

Those skilled in the art may further understand that various illustrative logical blocks and steps listed in the embodiments of the present disclosure may be implemented by electronic hardware, computer software, or a combination of them. Whether such functionality is implemented by hardware or software depends upon the particular application and design requirements of the overall system. Those skilled in the art may use various methods to implement the functions for each particular application, but it should not be understood that such implementation goes beyond the protection scope of the embodiments of the present disclosure.

The present disclosure further provides an apparatus for measurement. The apparatus for communication includes a processor, and when the processor invokes a computer program in a memory, any one of the foregoing method embodiments is implemented.

The present disclosure further provides a non-transitory computer-readable storage medium, where an instruction is stored on the non-transitory computer-readable storage medium. When the instruction is executed by a computer, the function of any one of the foregoing method embodiments is implemented.

The present disclosure further provides a computer program product. When the computer program product is executed by a computer, the function of any one of the foregoing method embodiments is implemented.

The present disclosure provides a computer program. When the computer program runs on a computer, the computer is enabled to perform any one of the foregoing method embodiments.

All or some of the foregoing embodiments may be implemented by using software, hardware, firmware, or any combination of them. When software is used to implement the embodiments, all or some of the embodiments may be implemented in a form of a computer program product. The computer program product includes one or more computer programs. When the computer program is loaded and executed on a computer, the procedures or functions according to the embodiments of the present disclosure are all or partially generated. The computer may be a general-purpose computer, a dedicated computer, a computer network, or another programmable apparatus. The computer program may be stored in a computer-readable storage medium or transmitted from one computer-readable storage medium to another computer-readable storage medium. For example, the computer program may be transmitted from a website, a computer, a server, or a data center to another website, another computer, another server, or another data center in a wired manner (for example, by using a coaxial cable, an optical fiber, a digital subscriber line (DSL)), or a wireless (e.g. infrared, wireless, microwave, etc.) manner. The computer-readable storage medium may be any usable medium accessible by a computer, or a data storage device, such as a server or a data center that integrates one or more usable medium. The usable medium may be a magnetic medium (for example, a floppy disk, a hard disk, or a magnetic tape), an optical medium (for example, a high-density digital video disk (DVD)), a semiconductor medium (for example, a solid state disk (SSD)), or the like.

Those of ordinary skill in the art may understand that various numerical numbers, such as “first” and “second”, involved in the present disclosure, are merely used for distinguishing for ease of description, are not used to limit the scope of the embodiments of the present disclosure, and also do not indicate a sequence.

“At least one” in the present disclosure may also be described as one or more. “More than one” may be two, three, four, or more, which is not limited in the present disclosure. In the embodiments of the present disclosure, for a technical feature, technical features in this kind of technical features are distinguished by using “first”, “second”, “third”, “A”, “B”, “C”, and “D”, etc. There is no sequential order or size order among the technical features described by using “first”, “second”, “third”, “A”, “B”, “C”, and “D”.

The correspondence shown in the tables in the present disclosure may be configured, or may be predefined. The value of the information in each table is merely an example, and may be configured as another value, which is not limited in the present disclosure. When the correspondence between the configuration information and the parameters is configured, it is not necessary to configure all correspondences shown in the tables. For example, in the table in the present disclosure, the correspondences shown in some rows may also not be configured. For another example, appropriate deformation adjustments may be made based on the above table, such as splitting, merging, etc. The names of the parameters shown in the titles of the above tables may also be other names that may be understood by the apparatus for communication, and the values or representations of the parameters may also be other values or representations that may be understood by the apparatus for communication. When the foregoing tables are implemented, other data structures may also be used, for example, an array, a queue, a container, a stack, a linear table, a pointer, a linked list, a tree, a graph, a structure, a class, a heap, a hash table, or the like, may be used.

Predefinition in the present disclosure may be understood as definition, pre-definition, storage, pre-storage, pre-negotiation, pre-configuration, curing, or pre-firing.

Those of ordinary skill in the art may be aware that, units and algorithm steps of the various examples described in combination with the the embodiments disclosed in the context may be implemented by electronic hardware or a combination of computer software and electronic hardware. Whether the functions are performed by hardware or software depends on particular applications and design constraint conditions of the technical solutions. Those skilled in the art may use different methods to implement the described functions for each particular application, but it should not be considered that such implementation goes beyond the scope of the present disclosure.

It may be clearly understood by those skilled in the art that, for the purpose of convenient and brief description, for the detailed working process of the foregoing system, apparatus, and unit, reference may be made to the corresponding process in the foregoing method embodiments, and details are not described here again.

The foregoing descriptions are merely specific implementations of the present disclosure, but the protection scope of the present disclosure is not limited to this. Any changes or substitutions that may be easily conceived of by those skilled in the art within the technical scope disclosed in the present disclosure, should be covered within the protection scope of the present disclosure. Therefore, the protection scope of the present disclosure shall be subject to the protection scope of the claims.

1. A method for measurement, performed by a terminal, and comprising:
in response to a first condition-based mobility configuration and a second condition-based mobility configuration being jointly configured, initiating at least one of a measurement or an evaluation corresponding to the first condition-based mobility configuration.

2. The method according to claim 1, further comprising:
initiating at least one of a measurement or an evaluation corresponding to the second condition-based mobility configuration based on at least one of a measurement result or an evaluation result corresponding to the first condition-based mobility configuration.

3. The method according to claim 1, wherein,
the first condition-based mobility configuration comprises a conditional handover (CHO) configuration, and the second condition-based mobility configuration comprises a conditional primary secondary cell addition (CPA) configuration or a conditional primary secondary cell change (CPC) configuration; or
the first condition-based mobility configuration comprises a CPA configuration or a CPC configuration, and the second condition-based mobility configuration comprises a CHO configuration.

4. The method according to claim 1, further comprising:
in response to receiving indication information that indicates an association relationship between the first condition-based mobility configuration and the second condition-based mobility configuration, determining that the first condition-based mobility configuration and the second condition-based mobility configuration are jointly configured.

5. The method according to claim 1, further comprising:
in response to the first condition-based mobility configuration and the second condition-based mobility configuration being comprised in same information and configured to the terminal, determining that the first condition-based mobility configuration and the second condition-based mobility configuration are jointly configured.

6. The method according to claim 2, wherein initiating at least one of the measurement or the evaluation corresponding to the first condition-based mobility configuration comprises:
initiating at least one of a measurement or an evaluation corresponding to at least one event corresponding to an execution condition of the first condition-based mobility configuration.

7. The method according to claim 2, wherein initiating at least one of the measurement or the evaluation corresponding to the second condition-based mobility configuration based on at least one of the measurement result or the evaluation result corresponding to the first condition-based mobility configuration comprises one or more of:
in response to an execution condition of the first condition-based mobility configuration being satisfied, initiating at least one of the measurement or the evaluation corresponding to the second condition-based mobility configuration; and
in response to an event corresponding to an execution condition of the first condition-based mobility configuration being satisfied, initiating at least one of the measurement or the evaluation corresponding to the second condition-based mobility configuration.

8. The method according to claim 2, further comprising:
stopping at least one of the measurement or the evaluation corresponding to the second condition-based mobility configuration based on at least one of the measurement result or the evaluation result corresponding to the first condition-based mobility configuration.

9. The method according to claim 8, wherein stopping at least one of the measurement or the evaluation corresponding to the second condition-based mobility configuration based on at least one of the measurement result or the evaluation result corresponding to the first condition-based mobility configuration comprises any one or more of:
in response to the execution condition of the first condition-based mobility configuration being not satisfied, stopping at least one of the measurement or the evaluation corresponding to the second condition-based mobility configuration; and
in response to an event corresponding to the execution condition of the first condition-based mobility configuration being not satisfied, stopping at least one of the measurement or the evaluation corresponding to the second condition-based mobility configuration.

10. The method according to claim further comprising one or more of:
according to at least one of the measurement result or the evaluation result of the execution condition of the first condition-based mobility configuration, determining whether the execution condition of the first condition-based mobility configuration is satisfied; and
according to at least one of the measurement result or the evaluation result of the execution condition of the first condition-based mobility configuration, determining whether an event corresponding to the execution condition of the first condition-based mobility configuration is satisfied.

11. A method for measurement, performed by a network device, and comprising:
jointly configuring a first condition-based mobility configuration and a second condition-based mobility configuration to a terminal.

12. The method according to claim 11, wherein the first condition-based mobility configuration comprises a CHO configuration, and the second condition-based mobility configuration comprises a CPA configuration or a CPC configuration; or
the first condition-based mobility configuration comprises a CPA configuration or a CPC configuration, and the second condition-based mobility configuration comprises a CHO configuration.

13. The method according to claim 11, wherein jointly configuring the first condition-based mobility configuration and the second condition-based mobility configuration to the terminal comprises:
configuring the first condition-based mobility configuration and the second condition-based mobility configuration respectively to the terminal, and transmitting indication information that indicates an association relationship between the first condition-based mobility configuration and the second condition-based mobility configuration to the terminal.

14. The method according to claim 11, wherein jointly configuring the first condition-based mobility configuration and the second condition-based mobility configuration to the terminal comprises:
configuring the first condition-based mobility configuration and the second condition-based mobility configuration to the terminal by comprising the first condition-based mobility configuration and the second condition-based mobility configuration in same information.

15. (canceled)

16. (canceled)

17. An apparatus for communication, comprising a processor and a memory, wherein the memory stores a computer program, and the processor executes the computer program stored in the memory to enable the apparatus for communication to execute a method for measurement, wherein the method comprises:
in response to a first condition-based mobility configuration and a second condition-based mobility configuration being jointly configured, initiating at least one of a measurement or an evaluation corresponding to the first condition-based mobility configuration.

18. An apparatus for communication, comprising a processor and an interface circuit, wherein,
the interface circuit is configured to receive a code instruction and transmit the code instruction to the processor; and
the processor is configured to run the code instruction to execute the method according to claim 1.

19. A non-transitory computer-readable storage medium, configured to store an instruction, wherein, when the instruction is executed, the method according to claim 1 is enabled to be implemented.

20. An apparatus for communication, comprising a processor and a memory, wherein the memory stores a computer program, and the processor executes the computer program stored in the memory to enable the apparatus for communication to execute the method according to claim 11.

21. An apparatus for communication, comprising a processor and an interface circuit, wherein,
the interface circuit is configured to receive a code instruction and transmit the code instruction to the processor; and
the processor is configured to run the code instruction to execute the method according to claim 11.

22. A non-transitory computer-readable storage medium, configured to store an instruction, wherein, when the instruction is executed, the method according to claim 11 is enabled to be implemented.
